(19) United States
(12) Patent Application Publication
(10) Pub. No.: US 2008/0130675 A1
(43) Pub. Date: Jun. 5, 2008

(54) Method and System for Data Traffic Integration Using Dynamic Data Packet Fragmentation

(75) Inventors: Ying-Leh Lin, Franklin, MA (US); Liang Guo, Brighton, MA (US); Whay Chiou Lee, Cambridge, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/565,807

(22) Filed: Dec. 1, 2006

(51) Int. Cl. H04B 7/212

(52) U.S. Cl. 370/442

(57) ABSTRACT

A device (10) and method (20) for integrating data traffic, such as isochronous (ISO) data packets and best-effort (BE) data packets, into a data transmission time frame. The method (20) includes defining a BE transmission interval (BETI) within the data transmission time frame, assigning all or a portion of the BE data packet in the BETI, or fragmenting the BE data packet if the BE data packet is larger than the BETI. The method dynamically fragments the BE data packet into a first fragment, equal in size to the BETI, that is assigned to the BETI, and a second fragment, which is queued. The method assigns BE data packets and fragments in this manner until they have been assigned to the BETI. The device (10) includes a scheduler for assigning BE data packet in the BETI and a fragmenter for fragmenting the BE data packet when larger than the BETI.

### BACKGROUND OF THE INVENTION

1. Field of the Invention

The invention relates to integrated data traffic communications. More particularly, the invention relates to methods and systems for integrating packet data traffic using dynamic packet fragmentation.

2. Description of the Related Art

Packet switched networks, such as the Internet Protocol, involve the use of data that is broken down into packets and labeled or otherwise provided with header or other information regarding the data origin, destination and the data's sequence within the original data file. The data packets are routed individually between communication system nodes, over shared data links, and re-assembled at the destination. The ability to integrate different kinds of packetized information, e.g., isochronous (ISO) data traffic and “best-effort” (BE) data traffic, over a shared link, often with limited bandwidth, has become increasingly important in managing data traffic in such networks.

Packets associated with isochronous data traffic are time-sensitive such that they must be delivered within certain time constraints to maintain quality. Isochronous traffic includes voice data and digital video transmission data. Other data packets that are less time constrained are considered “best-effort” (BE) packets and do not necessarily need to be delivered within a certain time period. However, in integrated packet switched networks, BE packets of variable size can hinder the ability of the network to guarantee no more than a certain amount of packet delay and delay variation for ISO packets. For example, oversized BE packets can cause relatively significant delay of ISO packets.

Conventional methods for managing integrated data traffic include frame-based time-division (FBTD) scheduling, in which time is divided into fixed-length frames, where the length of each frame is set to be equal to the ISO packet transmission period. Each frame begins with an ISO transmission interval (ITI), during which ISO packets can be delivered, and ends with a BE transmission interval (BETI), during which BE packets can be delivered. To guarantee that any delays or delay variations of ISO packets do not rise above an acceptable level, oversized BE packets that can not fit in a BETI are fragmented.

Conventional methods for fragmenting packets can be grouped into two categories: fixed size packet fragmentation and dynamic packet fragmentation. Fixed size packet fragmentation methods typically estimate the speed of the shared link, then calculate the maximum fragment size allowed that would not delay transmission of any ISO packet. The calculated maximum fragment size then is applied to all data packets to be transmitted over the shared link, e.g., by setting the maximum transmission unit (MTU) size, or by using a packet fragmenter. To ensure in-time delivery of ISO packets, the fragment size must be set to accommodate the largest possible number of active ISO sessions. Therefore, the system suffers lower efficiency when the number of active ISO sessions is relatively small.

One example of a conventional dynamic packet fragmentation method is the Next-Fit method. In this method, data packets are processed in first-in-first-out (FIFO) order. If the data packet at the head of queue fits in the BETI, the packet is delivered. If the data packet at the head of queue does not fit in the BETI, the packet either is delayed until the next available BETI, or fragmented if the size of the remaining window is greater than a certain predetermined size. Although such method makes use of dynamic fragmentation to improve efficiency, the method also may introduce unnecessary packet fragmentation, thus reducing efficiency.

### BRIEF DESCRIPTION OF THE DRAWINGS

FIG. 1 is a block diagram of a system for integrating data traffic using dynamic data packet fragmentation;

FIG. 2 is a flow chart that schematically illustrates a method for integrating data traffic using dynamic data packet fragmentation;

FIG. 3 is a diagram of a data transmission time frame;

FIG. 4 is a diagram of a representative data structure for a set of first-in-first-out (FIFO) queues used to support the implementation of packet queuing systems (PQS) and fragment queuing systems (FQS) in the system of FIG. 1 and the method for FIG. 2;

FIG. 5 is a flow chart that schematically illustrates the implementation of a best-fit algorithm used in the method that is schematically illustrated in FIG. 2; and

FIG. 6 is a diagram of a best effort (BE) data packet showing fragmentation and subsequent placement of fragments.

### DETAILED DESCRIPTION

In the following description, like reference numerals indicate like components to enhance the understanding of the graphics scaling method and apparatus through the description of the drawings. Also, although specific features, configurations and arrangements are discussed hereinbelow, it should be understood that such specificity is for illustrative purposes only. A person skilled in the relevant art will recognize that other steps, configurations and arrangements are useful without departing from the spirit and scope of the invention.

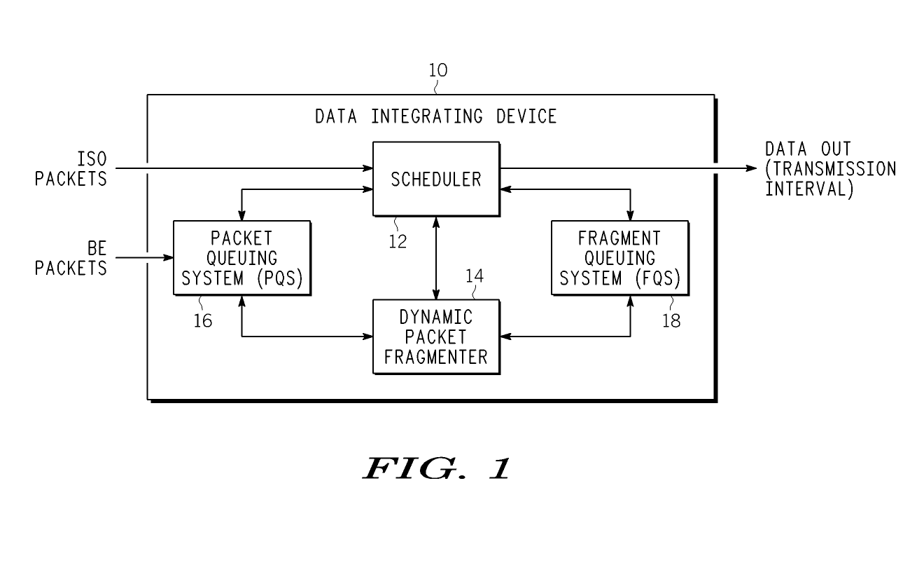

Referring to FIG. 1, shown is a block diagram of a data integrating device or system 10 for use in integrating data traffic, such as packetized isochronous (ISO) data traffic and “best-effort” (BE) data traffic, over a shared link. The data integrating device or system 10 can be partially or completely any suitable device or subsystem (or portion thereof) for integrating data traffic. Such devices can include, for example, any home networking device, any signal converter or decoder (set-top) box or other suitable computing device, including a residential gateway, a home media server system, a computer, or an internet protocol (IP), satellite or cable digital video recorder. All or a portion of the system or device 10 can be comprised of any suitable structure or arrangement, e.g., one or more integrated circuits.

The device 10 can be part of any suitable home networking product that manages the flow of data traffic in a home network. For example, in a home network arrangement in which ISO data traffic shares a broadband modem with BE data traffic, the device 10 can be part of the system configuration between the network gateway and the broadband modem. The broadband modem connects to an Internet Service Provider (ISP) or other suitable network that delivers data to the home network.

The device 10 can be partially or completely configured in the form of hardware circuitry and/or other hardware components within a larger device or group of components. Alternatively, the device 10 can be partially or completely configured in the form of software, e.g., as processing instructions and/or one or more sets of logic or computer code. In such configuration, the logic or processing instructions typically are stored in a data storage device (not shown), which typically is coupled to a processor or controller (not shown). The processor accesses the necessary instructions from the data storage device and executes the instructions or transfers the instructions to the appropriate location within the device 10.

The device 10 includes a scheduler 12 and a dynamic packet fragmenter 14 coupled to the scheduler 12. The device 10 also can include a packet queuing system (PQS) or data packet queuing system 16 and a fragment queuing system (FQS) or data fragment queuing system 18. As shown, the scheduler 12 and the dynamic packet fragmenter 14 are coupled to each of the packet queuing system 16 and the fragment queuing system 18. One or more of the scheduler 12, the dynamic packet fragmenter 14, the packet queuing system 16 and the fragment queuing system 18 can be comprised partially or completely of any suitable structure or arrangement, e.g., one or more integrated circuits. Also, it should be understood that the device 10 includes other components, hardware and software (not shown) that are used for the operation of other features and functions of the device 10 not specifically described herein.

The device 10 receives data traffic, in the form of ISO data packets and BE data packets, from an appropriate ISO data traffic source (not shown) and an appropriate BE data traffic source (not shown), respectively. Such data traffic sources can deliver the respective data packets to the device via an appropriate communications channel or network connection, e.g., via a multimedia end device, such as a voice over Internet protocol (VoIP) terminal and a personal computer. As shown, the ISO data packets typically are delivered to the scheduler 12 and the BE data packets typically are delivered to the packet queuing system 16. The device 10 outputs or transmits integrated data, via the scheduler 12, in the form of data transmission time frames, as will be discussed in greater detail hereinbelow.

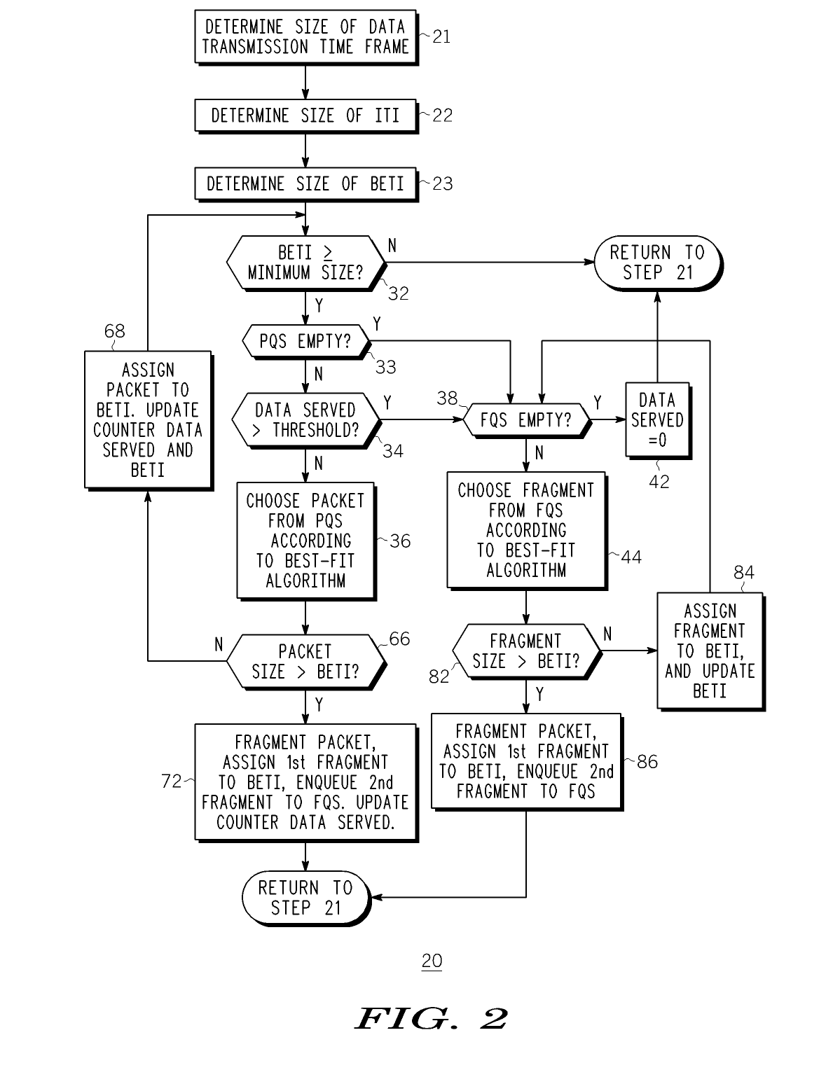

Referring now to FIG. 2, with continuing reference to FIG. 1, shown is a flow chart that schematically illustrates a method 20 for integrating data traffic using dynamic data packet fragmentation. The method 20 will be described along with the operation of the device 10. As discussed hereinabove, managing integrated data traffic includes dividing data transmission time into fixed-length frames, each beginning with an ISO transmission interval (ITI), during which ISO data packets can be delivered, and ending with a BE transmission interval (BETI), during which BE data packets can be delivered.

The method 20 includes a step 21 of determining the size of a data transmission time frame in accordance with a given ISO packet transmission period. The ISO packet transmission period can be obtained through a device level signaling protocol, such as session initiation protocol (SIP). The method 20 also includes a step 22 of determining the size of the ITI in the current data transmission time frame. For example, the size of the ITI is based on the number of ISO packets currently needed to be delivered. The method 20 also includes a step 23 of defining or determining the size of BETI in the current data transmission time frame.

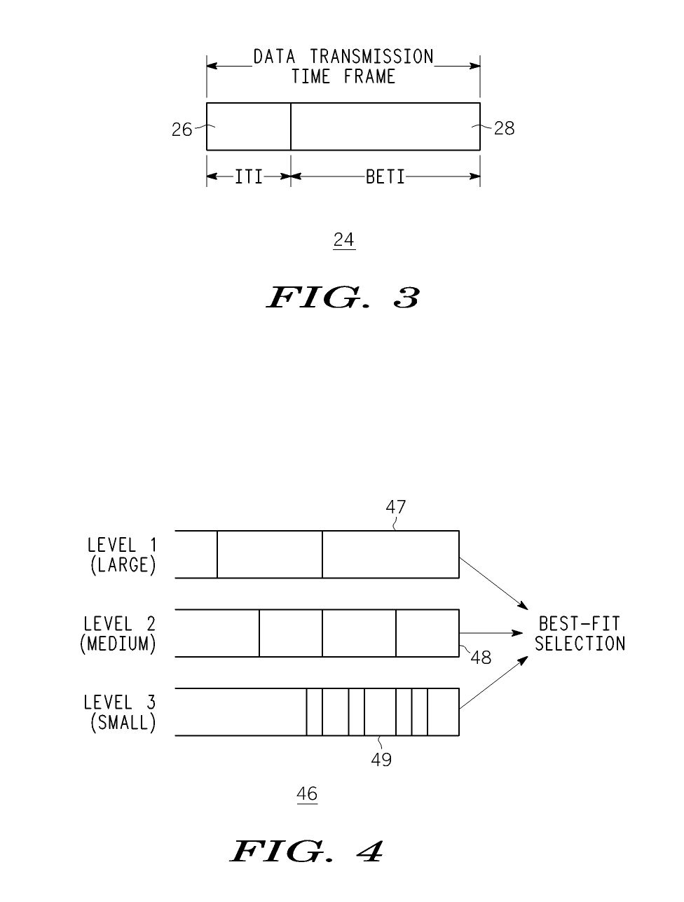

A diagram of a typical data transmission time frame 24 is shown in FIG. 3. A first portion 26 of the data transmission time frame 24 includes the ITI. A second portion 28 of the data transmission time frame 24 includes the BETI. The BETI typically is defined based on the overall size of the data transmission time frame and the size of the ITI. For example, the BETI can be defined as the difference between the size of the data transmission time frame 24 and the size of the ITI 26. In the device 10, the scheduler 12 can define the size of the BETI based on the ISO data received and the size of the data transmission time frame 24. The scheduler 12 then can communicate such information to the dynamic packet fragmenter 14, the packet queuing system 16 and the fragment queuing system 18.

Once the current BETI is defined, the method 20 can begin to serve or assign BE data packets to the BETI. In general, the method 20 assigns the largest available BE data packet that will fit in the currently-defined BETI from the available queues of BE data packets, as will be discussed in greater detail hereinbelow. However, if there is no available BE data packet that will fit in the current BETI, the method 20 will dynamically fragment the current BE data packet so that the first fragment will fit in and can be assigned to the current BETI. The second fragment is queued in a fragment queuing system. Then, in general, the method 20 selects the largest available BE data packet or BE fragment from the available packet queuing system for assignment to the next defined BETI. Such process continues until the BE data packets and/or the BE fragments are assigned to a given BETI, i.e., until the BE data packet queuing system and the BE fragment queuing system are empty.

The method 20 includes a step 32 of determining whether the defined BETI is greater than or equal to a minimum size. In the device 10, such step is performed by an appropriate component, e.g., the dynamic packet fragmenter 14. The minimum size can be predetermined, and typically is based on various system parameters whose values may be unique to the given method. For example, the minimum size can be based on protocol header size or implementation specific efficiency criteria. If the BETI is not greater than or equal to the minimum size, the method 20 terminates. If the BETI is greater than or equal to the minimum size, the method 20 proceeds to a step 33 of determining if the packet queuing system is empty. In the device 10, the determining step 33 can be performed by the dynamic packet fragmenter 14 or other appropriate components in the device 10.

If the packet queuing system is empty, the method 20 continues to a step 38 of determining if the BE fragment queuing system is empty, as will be discussed in greater detail hereinbelow. If the packet queuing system is not empty, the method continues to a step 34 of determining if the volume (e.g., the number of bytes) of BE data packets that have been served or assigned to a BETI is greater than a given threshold value. The volume of BE data packets served is recorded by a counter, e.g., a counter named Data Served.

In the device 10, the determining step 34 can be performed by the dynamic packet fragmenter 14 or other appropriate components in the device 10. With respect to the determining step 34, the threshold value can be predetermined, and typically is based on various system parameters whose values may be unique to the given method. For example, the system parameters may include a timeout period for packet discard.

If the volume of BE data packets that have been served or assigned to a BETI is less than or equal to the given threshold value, the method 20 continues to a step 36 of choosing the best-fit BE data packet for assignment in the BETI according to a best-fit algorithm, as will be discussed in greater detail hereinbelow. Also, if the volume of BE data packets that has been served or assigned to a BETI is greater than the given threshold value, the method 20 continues to the step 38 of determining if the BE fragment queuing system is empty, as will be discussed in greater detail hereinbelow. In the device 10, one or both of the step 36 and the step 38 can be performed by the dynamic packet fragmenter 14 or by other appropriate components in the device 10.

According to the step 38, if the BE fragment queuing system is empty, i.e., if there is no backlog of BE fragments, the method 20 resets the counter (Data Served) to zero (shown generally as 42) and the method 20 terminates. If the BE fragment queuing system is not empty, the method 20 continues to a step 44 of choosing the best-fit BE fragment for assignment in the BETI according to a best-fit algorithm. In the device 10, the choosing step 44 can be performed by the dynamic packet fragmenter 14 or by other appropriate components in the device 10.

As stated hereinabove, according to the determining step 34, if the volume of BE data packets that has been served or assigned to a BETI is less than or equal to the given threshold value, the step 36 of choosing the best-fit BE data packet according to a best-fit algorithm is performed. The BE data packet best suited for assignment to the BETI is chosen from among the available BE data packets in the packet queuing system (PQS). As shown in FIG. 1, the BE data packets that are received by the device 10 are delivered directly to the packet queuing system 16.

The BE data packets delivered to the packet queuing system 16 are sorted or organized within one or more queue levels according to any suitable criteria, such as the size of the packet delivered to the packet queuing system 16. For example, BE data packets delivered to a particular level of the packet queuing system 16 can be queued on a first-in-first-out (FIFO) basis at that level.

For example, referring to FIG. 4, shown is a queuing system 46, such as a packet queuing system or a fragment queuing system, that can be used in the device 10 and by the method 20. The queuing system 46 can have a plurality of queue levels 47, 48, 49, each accepting data packets within a different size range. For example, if the queuing system 46 is a BE data packet queuing system, the first queue level 47 may accept BE data packets having a size greater than or equal to 500 bytes in length, the second queue level 48 may accept BE data packets having a size greater than or equal to 100 but less than 500 bytes in length, and the third queue level 49 may accept BE data packets having a size less than 100 bytes in length. Furthermore, within a given queue level, incoming BE data packets can be accepted or queued on a FIFO basis. Similarly, a fragment queuing system may include a similar number of queue levels with the same or different level size ranges, and the same or different queuing arrangement within a given queue level.

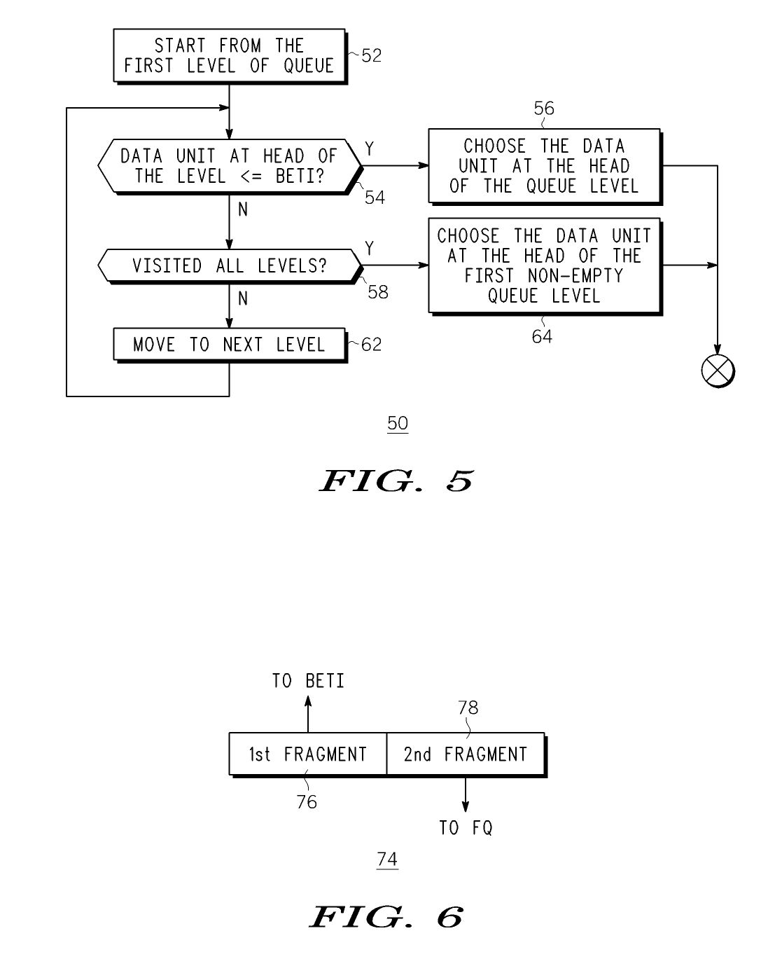

Referring now to FIG. 5, shown is a flow chart 50 that schematically illustrates the best-fit algorithm used in the method 20, e.g., as part of the step 36 of selecting the best-fit BE data packet for assignment in the BETI and/or as part of the step 44 of choosing the best-fit BE fragment for assignment in the BETI. It should be understood that the best-fit algorithm shown in FIG. 5 is suitable for use with any suitable data packet queuing system, e.g., the packet queuing system 16 and/or the fragment queuing system 18. In general, the best-fit algorithm chooses the largest-sized data packet unit will fit in a BETI from among a plurality of data units in a multi-level queuing system. The data units can be BE data packets, e.g., in the packet queuing system 16, or BE fragments, e.g., in the fragment queuing system 18. Thus, the inputs to the best-fit algorithm are the size of the BETI and the sizes of data units in a multi-level data packet queuing system.

Initially, the algorithm typically starts at the first queue level of the multi-level data packet queuing system, i.e., the queue level having the largest data units. Such is shown generally as a step 52 in the flow chart 50. For example, in the queuing system 46 shown in FIG. 4, the algorithm would start from the queue level 47.

The flow chart 50 includes a step 54 of determining whether the size of the data unit at the head of the starting queue level is less than or equal to the size of the BETI. That is, the step 54 determines whether the data unit at the head of queue can fit in the BETI. If the data unit at the head of queue can fit in the BETI, the data packet is chosen for possible assignment in the BETI. Such is shown generally as a step 56. If the size of the data packet at the head of the starting queue level is greater than the size of the BETI, the data packet is too large for the BETI and will not be chosen. If the data packet at the head of the starting queue level is not chosen, the algorithm then determines whether all queue levels have been visited. Such determination is shown generally as a step 58.

If not all of the queue levels have been visited, the algorithm moves to or visits the next queue level. Such is shown generally as a step 62. The algorithm then returns to the step 54 of determining whether the size of the data unit at the head of the new or current queue level is less than or equal to the size of the BETI. If so, the particular data unit is chosen for possible assignment in the BETI (step 56). If not, the algorithm determines if all queue levels have been visited or approached (step 58). If not all queue levels have been visited, the algorithm moves to the next queue level (step 62) and the process cycles back to the step 54.

If no data unit has been chosen for possible assignment in the BETI and all queue levels in the packet queuing system have been visited, the data unit at the head of the first non-empty queue level is chosen for possible assignment to the BETI. Such is shown generally as a step 64. This scenario usually occurs when the data unit at the head of every queue level in the packet queuing system is too large for assignment in the BETI. As will be discussed in greater detail hereinbelow, the data unit chosen as a result of the step 64 usually will be fragmented during a subsequent step to be performed by the method 20. Once a data unit is chosen for possible assignment to the BETI, via either the step 56 or the step 64, the process terminates.

Returning again to FIG. 2, once the step 36 of selecting the best-fit BE data packet for assignment in the BETI according to the best-fit algorithm is performed, the method can begin serving or assigning all or a portion of the selected BE data packet. The method 20 includes a step 66 of determining whether the size of the selected BE data packet is greater than the defined (or current) size of the BETI. If the size of the selected BE data packet is not greater than the BETI, the method 20 proceeds to a step 68 of assigning the selected data packet to the BETI. In the device 10, one or both of the determining step 66 and the assigning step 68 can be performed by the dynamic packet fragmenter 14 or by one or more other appropriate components in the device 10.

As a result of the packet assignment step 68, the size of the BETI, as well as the counter (Data Served) are updated accordingly. More specifically, the size of the BETI is reduced by the size of the newly assigned BE data packet, and the value of the counter (Data Served) is increased by the size of the newly assigned BE data packet. Once the packet assignment step 68 is performed, the method 20 cycles back to the step 32 of determining whether the defined BETI still is greater than or equal to a minimum size, herein previously described.

If the size of the selected BE data packet is greater than the BETI, the selected BE data packet should be fragmented. The method 20 includes a step 72 of dynamically fragmenting the selected BE data packet into a first BE fragment and a second BE fragment. The fragmenting step 72 fragments the selected BE data packet in such a way that the size of the first BE fragment is equal to the current size of the BETI.

Alternatively, the fragmenting step 72 can fragment the selected BE data packet to be smaller in size than the BETI when fragmentation results in one or more of the BE fragments having a minimum size. The minimum size can be predetermined and/or based on any suitable number of system parameters whose values may be unique to the given method, as described previously herein.

Referring now to FIG. 6, shown is a diagram of a BE data packet 74, showing fragmentation and subsequent placement of the BE fragments. The step 72 fragments the BE data packet 74 into a first BE fragment 76 and a second BE fragment 78. The fragmenting step 72 assigns the first BE fragment 76 to the BETI and queues the second BE fragment 78 in the fragment queuing system 18.

In the device 10, the dynamic packet fragmenter 14 performs the data packet fragmentation, e.g., the fragmenting step 72. The dynamic packet fragmenter 14 places the BE fragments in appropriate queue levels in the fragment queuing system 18. For example, the dynamic packet fragmenter 14 can transmit the first BE fragment to the scheduler 12 for assignment in the BETI. Also, the dynamic packet fragmenter 14 can transmit the second BE fragment to the fragment queuing system 18 for queuing therein.

As discussed previously herein, in conventional methods for managing integrated data packets, packets that do not fit in the BETI either are delayed or are fragmented when the current size of the BETI is greater than a predetermined size. The fragmenting step 72 in the method 20 eliminates the inefficiency associated with delaying or selectively fragmenting data packets, such as is done in many conventional methods.

As a result of the fragmenting step 72, the value of the counter (Data Served) is increased by the size of the newly assigned BE fragment. Also, since the first BE fragment is equal in size to the BETI, the size of the BETI is reduced to zero once the first BE fragment is assigned therein. After the fragmenting step 72 is performed, the method terminates.

Returning to the step 44 of the method 20, if a given volume of BE data packets has been served or if the packet queuing system is empty, the fragment queuing system is next served. That is, the method 20 performs the step 44 of choosing the best-fit BE fragment for assignment in the BETI according to a best-fit algorithm, as long as the fragment queuing system is not empty (step 38).

In the method 20, the determining step 34 provides a counter for the method 20 to keep track of the volume of BE data packets assigned to the BETI before a BE fragment is assigned. In this manner, the determining step 34 makes sure that when the first BE fragment is assigned to the BETI, the second BE fragment or subsequent fragments from that same BE fragment are assigned to the BETI within a given volume of other data packets being assigned. Thus, the entire BE data packet (in the form of two or more BE fragments) is assigned to the BETI within a given volume of data packets assigned. This improves overall system efficiency, as many system processes rely on the complete delivery of data packets before those processes can be resumed or completed.

The BE fragment choosing step 44 is performed similar to the BE data packet choosing step 36, except the algorithm is being applied to the fragment queuing system rather than to the packet queuing system. The choosing process is similar. In general, the largest BE fragment in the fragment queuing system that will fit in the BETI is selected for assignment in the BETI. As with the packet queuing system, the fragment queuing system can include a plurality of BE fragments sorted or arranged by size within a plurality of fragment queuing system levels. Within a given queue level, the BE fragments can be arranged on a FIFO basis.

Once the step 44 of selecting the best-fit BE fragment for assignment in the BETI according to the best-fit algorithm is performed, the method 20 can begin serving or assigning the selected BE fragment (or a portion thereof if the size of the fragment is greater than the size of the BETI). The method 20 includes a step 82 of determining whether the size of the selected BE fragment is greater than the current size of the BETI. If the size of the selected BE fragment is not greater than the BETI, the method 20 proceeds to a step 84 of assigning the selected BE fragment to the BETI. In the device 10, one or both of the determining step 82 and the assigning step 84 can be performed by the scheduler 12 or by one or more other appropriate components in the device 10.

As a result of the fragment assignment step 84, the size of the BETI available for future packet assignment is reduced by the size of the newly assigned fragment. Once the fragment assignment step 84 is performed, the method 20 returns to the step 32 of determining whether the defined BETI is greater than or equal to a minimum size, herein previously described, and the process of allocating the BETI to serve more fragments continues. It should be noted that the value of the counter (Data Served) is not updated because all of the fragments need to be served to guarantee timely delivery of these fragments.

If the size of the selected BE fragment is greater than the BETI, the selected BE fragment should be fragmented again. The method 20 includes a step 86 of dynamically fragmenting the selected fragment into another set of fragments, e.g., a first subfragment or first BE data subfragment and a second subfragment or second BE data subfragment. Similar to the fragmenting step 72, the fragmenting step 82 fragments the selected BE fragment in such a way that the size of the first subfragment is equal to the current size of the BETI. The fragment fragmenting step 82 assigns the first subfragment to the BETI and queues the second subfragment in the fragment queuing system 18. After the fragmenting step 82 is performed, the process terminates. It should be noted that the value of the counter (Data Served) is not updated because all of the fragments need to be served to guarantee timely delivery of these fragments.

In the device 10, the dynamic packet fragmenter 14 performs the data fragment fragmentation, e.g., the fragmenting step 86. The dynamic packet fragmenter 14 can transmit the data packet fragments to any suitable component in the device 10. For example, the dynamic packet fragmenter 14 can transmit the first BE fragment to the scheduler 12 for assignment in the BETI. Also, the dynamic packet fragmenter 14 can transmit the second BE fragment to the fragment queuing system 18 for queuing therein.

The method 20 continues in the manner described hereinabove until the packet queuing system 16 is empty or until a given amount of BE data has been assigned to the BETI (step 34). The method 20 then serves the fragment queuing system 18 until the fragment queuing system 18 is empty. Alternatively, the scheduler 12 can alternate between serving the packet queuing system 16 and serving the fragment queuing system 18 in any other suitable manner.

The method shown in FIG. 2 and FIG. 5 may be implemented in a general, multi-purpose or single purpose processor. Such a processor will execute instructions, either at the assembly, compiled or machine-level, to perform that process. Those instructions can be written by one of ordinary skill in the art following the description of FIGS. 2 and 5 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the dynamic data packet fragmentation method and system herein described without departing from the spirit and scope of the invention as defined by the appended claims and their full scope of equivalents.

1. A computer program embodied in a computer-readable medium for integrating at least one isochronous (ISO) data packet and at least one best-effort (BE) data packet in a data transmission time frame, the data transmission time frame including an ISO transmission interval (ITI) having the at least one ISO data packet assigned thereto, the program comprising:
instructions for defining a BE transmission interval (BETI) within the data transmission time frame, wherein the BETI is dimensioned based on the difference between the size of the data transmission time frame and the size of the ITI;
instructions for assigning at least a portion of the at least one BE data packet to the BETI based on the size of the BETI and the size of the BE data packet; and
instructions for fragmenting the at least one BE data packet into a first BE fragment having a size equal to the BETI and a second BE fragment,
wherein, if the size of the BE data packet is less than or equal to the size of the BETI, the BE data packet is assigned to the BETI, and
wherein, if the size of the BE data packet is greater than the size of the BETI, the BE data packet is fragmented into the first BE fragment and the second BE fragment, and the first BE fragment is assigned to the BETI.

2. The program as recited in claim 1, wherein the at least one BE data packet is part of a queue of data packets from which to select for assignment to the BETI, wherein the queue of data packets includes at least one BE data packet and at least one BE fragment, and wherein, if a BE data packet is assigned to the BETI, the instructions for assigning the at least one BE data packet to the BETI are repeated using the next BE data packet in the queue of data packets.

3. The program as recited in claim 2, wherein, if there are no more BE data packets for assigning to the BETI, the instructions for assigning the at least one BE data packet to the BETI are repeated using the next BE fragment in the queue of data packets.

4. The program as recited in claim 1, wherein the at least one BE data packet is part of a packet queuing system (PQS) having a plurality of queue levels, wherein at least one of the queue levels is based on a first-in-first-out (FIFO) order, and wherein the PQS is based on a largest-fit-first order.

5. The program as recited in claim 1, wherein the at least one second BE fragment is part of a fragment queuing system (FQS) having a plurality of queue levels, wherein at least one of the queue levels is based on a first-in-first-out (FIFO) order, and wherein the FQS is based on a largest-fit-first order.

6. The program as recited in claim 1, wherein the at least one BE data packet is part of a queue of data packets from which to select for assignment to the BETI, wherein the queue of data packets includes at least one BE data packet and at least one BE fragment, and wherein, if a predetermined amount of BE data packets have been assigned to the BETI, the instructions for assigning the at least one BE data packet to the BETI are repeated using the next BE fragment.

7. The program as recited in claim 1, wherein the instructions for defining the BETI further comprise instructions for defining a BETI having a minimum size.

8. The program as recited in claim 1, wherein the instructions for fragmenting the at least one BE data packet further comprise instructions for fragmenting the at least one BE data packet into the first BE fragment and the second BE fragment based on whether the BETI is large enough to assign therein a BE fragment having a minimum size.

9. The program as recited in claim 1, further comprising instructions for transmitting the at least one ISO data packet and the at least one BE data packet integrated in the data transmission time frame.

10. A device for integrating at least one isochronous (ISO) data packet and at least one best-effort (BE) data packet in a data transmission time frame, the data transmission time frame having an isochronous (ISO) transmission interval (ITI) therein for assigning the at least one isochronous (ISO) data packet therein, the device comprising:
a scheduler configured to assign at least a portion of the at least one BE data packet to a BE transmission interval (BETI) within the data transmission time frame, wherein the BETI is dimensioned based on the difference between the size of the data transmission time frame and the size of the ITI; and
a fragmenter configured to fragment the at least one BE data packet into a first BE fragment having a size equal to the BETI and a second BE fragment, if the size of the at least one BE data packet is greater than the size of the BETI, and
wherein, if the fragmenter fragments the at least one BE data packet into the first BE fragment and the second BE fragment, the scheduler assigns the first BE fragment to the BETI.

11. The device as recited in claim 10, wherein the at least one BE data packet further comprises a plurality of data packets including at least one BE data packet and at least one BE fragment, and wherein the device further comprises a packet queuing system (PQS) for receiving the at least one BE data packet, wherein the scheduler selects from the PQS the BE data packet to assign to the BETI, wherein the packet queuing system (PQS) has a plurality of queue levels, wherein at least one of the queue levels is based on a first-in-first-out (FIFO) order, and wherein the PQS is based on a largest-fit-first order.

12. The device as recited in claim 10, wherein the at least one BE data packet further comprises a plurality of data packets including at least one BE data packet and at least one BE fragment, and wherein the device further comprises a fragment queuing system (FQS) for receiving the at least one BE fragment, wherein the scheduler selects from the FQS the BE fragment to assign to the BETI, wherein the fragment queue (FQS) has a plurality of queue levels, wherein at least one of the queue levels is based on a first-in-first-out (FIFO) order, and wherein the FQS is based on a largest-fit-first order.

13. The device as recited in claim 10, wherein the at least one BE data packet is part of a queue of data packets from which to select for assignment to the BETI, wherein the queue of data packets includes at least one BE data packet and at least one BE fragment, and wherein, if the scheduler has assigned a predetermined amount of BE packets to the BETI, the scheduler selects from among the at least one BE fragment to assign to the BETI.

14. The device as recited in claim 10, wherein the scheduler, before assigning at least a portion of the at least one BE data packet to the BETI, determines whether the BETI is large enough to assign therein a BE data packet having a minimum size.

15. The device as recited in claim 10, wherein the fragmenter fragments the at least one BE data packet into the first BE fragment and the second BE fragment based on whether the BETI is large enough to assign therein a BE packet fragment having a minimum size.

16. The device as recited in claim 10, wherein the device transmits the at least one ISO data packet and the at least one BE data packet integrated in the data transmission time frame.

17. The device as recited in claim 10, wherein at least one of the scheduler and the fragmenter is implemented in software executed by a computer.

18. The device as recited in claim 10, wherein at least one of the scheduler and the fragmenter is implemented in hardware.

19. The device as recited in claim 10, wherein at least one of the scheduler and the fragmenter is contained in a set-top box.

20. The device as recited in claim 10, wherein at least a portion of at least one of the scheduler and the fragmenter further comprises an integrated circuit.
